(19) United States
(12) Patent Application Publication
(10) Pub. No.: US 2015/0248899 A1
(43) Pub. Date: Sep. 3, 2015

(54) METHOD FOR FABRICATING A MAGNETIC SHIELD AT REDUCED COST AND WITH ENHANCED RELIABILITY

(71) Applicant: Western Digital (Fremont), LLC, Fremont, CA (US)

(72) Inventors: MINGJUN YU, SUNNYVALE, CA (US); DONGHONG LI, PLEASANTON, CA (US); LIEN-CHANG WANG, FREMONT, CA (US); LIEPING ZHONG, SAN JOSE, CA (US); TAO PAN, SAN JOSE, CA (US)

(21) Appl. No.: 14/299,914

(22) Filed: Jun. 9, 2014

Related U.S. Application Data
(60) Provisional application No. 61/946,583, filed on Feb. 28, 2014.

(51) Int. Cl. G11B 5/187

(52) U.S. Cl. CPC G11B 5/1871

(57) ABSTRACT

A method provides a magnetic transducer having an air-bearing surface. The method includes providing a main pole that has a plurality of sidewalls. The step of providing the main pole includes providing a trailing bevel. A side shield after the trailing bevel has been provided.

### CROSS-REFERENCE TO RELATED APPLICATIONS

This application claims priority to provisional U.S. Patent Application Ser. No. 61/946,583 (Atty. Docket No. F6892.P), filed on Feb. 28, 2014, which is hereby incorporated by reference in its entirety.

### BACKGROUND

FIG. 1 depicts a conventional method 10 for fabricating a conventional magnetic recording head. The method starts after a nonmagnetic intermediate layer, such as aluminum oxide, is provided. A trench is formed in the intermediate layer, via step 12. The trench has a location and footprint that is desired for the main pole being formed. A seed layer and high saturation magnetization pole materials are provided, via step 14. For example, a nonmagnetic conductive seed layer may be deposited and magnetic materials plated in the trench. The magnetic materials are planarized, via step 16. Thus, the main pole is substantially formed. However, the top of the main pole is substantially flat.

A portion of the intermediate layer near the pole in the region(s) in which the shields are to be fabricated is removed, via step 18. Step 18 may include providing a mask that covers the main pole and etching the exposed intermediate layer. The side shields may then be provided, via step 20. Step 20 may include plating the magnetic materials, such as NiFe, for the shield.

After the side shields are provided, the trailing bevel is fabricated, via step 22. Step 22 may include providing a mask recessed from the air-bearing surface (ABS) and ion milling the portion of the transducer that has been fabricated. Thus, part of the main pole materials are removed at a nonzero angle from perpendicular to the ABS. In addition, a portion of the side shield material(s) are also removed.

A write gap or seed layer may be deposited, via step 24. This step is performed after the trailing bevel has been provided in step 22. Thus, a nonmagnetic layer is provided on the top (trailing bevel) surface of the main pole. A trailing shield is then provided, via step 26. Step 26 may include depositing the material(s) for the trailing shield. Thus, a wraparound shield including the side and trailing shields may be formed.

FIG. 2 depicts an ABS view of a conventional magnetic recording head 50 formed using the method 10. The magnetic recording transducer 50 may be a perpendicular magnetic recording (PMR) head. The conventional magnetic recording transducer 50 may be a part of a merged head including the write transducer 50 and a read transducer (not shown). Alternatively, the magnetic recording head may be a write head including only the write transducer 50. The conventional transducer 50 includes an underlayer 52, side gap 54, main pole 60, side shields 70, top (write) gap 80, and optional top (trailing) shield 90.

The main pole 60 resides on an underlayer 52 and includes sidewalls. The underlayer 52 may include a leading shield. The sidewalls of the conventional main pole 60 form an angle with the down track direction at the ABS and may form a different angle with the down track direction at the distance recessed from the ABS. The width of the main pole 60 may also change in a direction recessed from the ABS.

The side shields 70 are separated from the main pole 60 by a side gap 54. The side shields 70 extend a distance back from the ABS. As can be seen in FIG. 2, the side shields 70 are separated from the trialing shield 90. Thus, there is a seam between the trailing shield 90 and the side shields 70 even if they are made of the same material.

Although the conventional magnetic recording head 50 functions, there are drawbacks. In particular, the conventional magnetic recording head 50 may suffer from defects due to the seam between the trailing shield 90 and the side shields 70. For example, reliability and adjacent track interference may be adversely affected. Accordingly, what is needed is a system and method for improving the performance of a magnetic recording head.

### BRIEF DESCRIPTION OF SEVERAL VIEWS OF THE DRAWINGS

FIG. 1 is a flow chart of a conventional method for fabricating a magnetic recording head.

FIG. 2 depicts a conventional magnetic recording disk drive.

FIG. 3 is a flow chart depicting an embodiment of a method for fabricating a magnetic recording transducer.

FIG. 4A-4C depict various views of an exemplary embodiment of a magnetic recording disk drive.

FIG. 5 depicts a flow chart of an exemplary embodiment of a method for providing a magnetic recording transducer.

FIG. 6 depicts a flow chart of another exemplary embodiment of a method for providing a magnetic recording transducer.

FIGS. 7A-7C through 13A-13C depict various views of an exemplary embodiment of a magnetic recording transducer fabricated using the method.

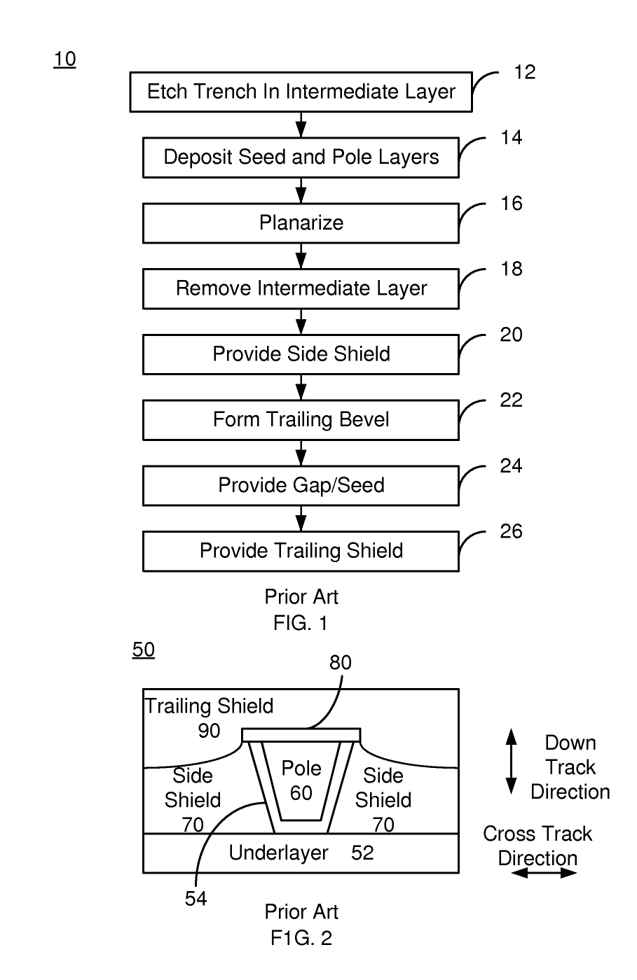

### DETAILED DESCRIPTION OF THE PREFERRED EMBODIMENTS

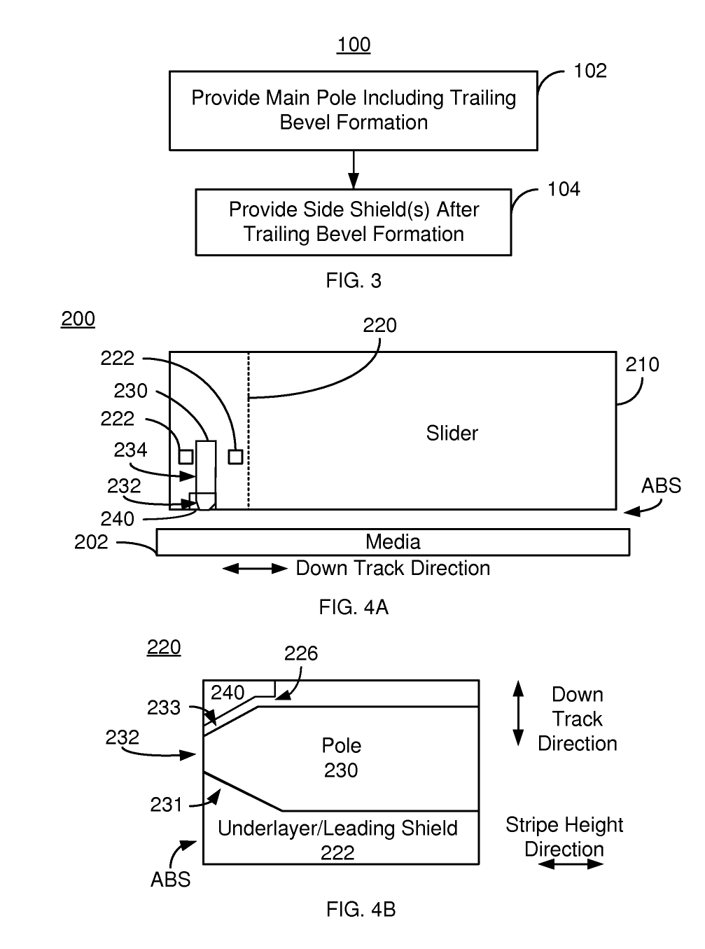

FIG. 3 depicts an exemplary embodiment of a method 100 for providing a magnetic recording transducer. For simplicity, some steps may be omitted, interleaved, combined, have multiple substeps and/or performed in another order unless otherwise specified. The method 100 is described in the context of providing a magnetic recording disk drive and transducer. However, the method 100 may be used to fabricate multiple magnetic recording transducers at substantially the same time. The method 100 is also described in the context of particular layers. A particular layer may include multiple materials and/or multiple sub-layers. The method 100 also may start after formation of other portions of the magnetic recording head. For example, the method 100 may start after a read transducer, return pole/shield and/or other structure have been fabricated. The method 100 may start after the intermediate layer in which the main pole is to be formed has already been provided.

A main pole including a trailing bevel is provided, via step 102. Step 102 includes forming a trench in the intermediate layer. The location and profile of the trench corresponds to the main pole. A seed layer, such as Ru, may be deposited in at least the trench. The seed layer may be nonmagnetic and may form at least part of a side gap for the transducer. The material(s) for the main pole may then be provided. For example, high saturation magnetization magnetic materials may be electroplated. The main pole material(s) may be planarized. The trailing bevel is then formed at the top of the main pole. For example, a portion of the top of the main pole recessed from the ABS may be covered by a mask. The main pole may then be ion milled at a nonzero angle from perpendicular to the ABS. A portion of the intermediate layer around the main pole may also be ion milled in this process.

After formation of the main pole, at least including the trailing bevel, the side shield(s) are provided, via step 104. In some embodiments, step 104 may include removing the intermediate layer adjacent to the main pole in the regions in which the side shield(s) are to be fabricated. For example, a gap layer may be provided on the main pole and a mask provided on the gap layer. The desired portion of the intermediate layer may then be removed, for example via a wet etch. A seed layer for the shield(s) may be deposited and the magnetic materials, such as NiFe, may be electroplated or otherwise deposited. Thus, a wraparound shield may be formed. In other embodiments, the trailing portion of the shield material(s) may be removed. Thus, side shields only can also be fabricated.

Using the method 100, a magnetic transducer having improved performance may be fabricated. The transition between the side shield and trailing shield may be interface-free. Thus, performance of the shield(s) may be improved. Further, fabrication of the transducer may be simplified.

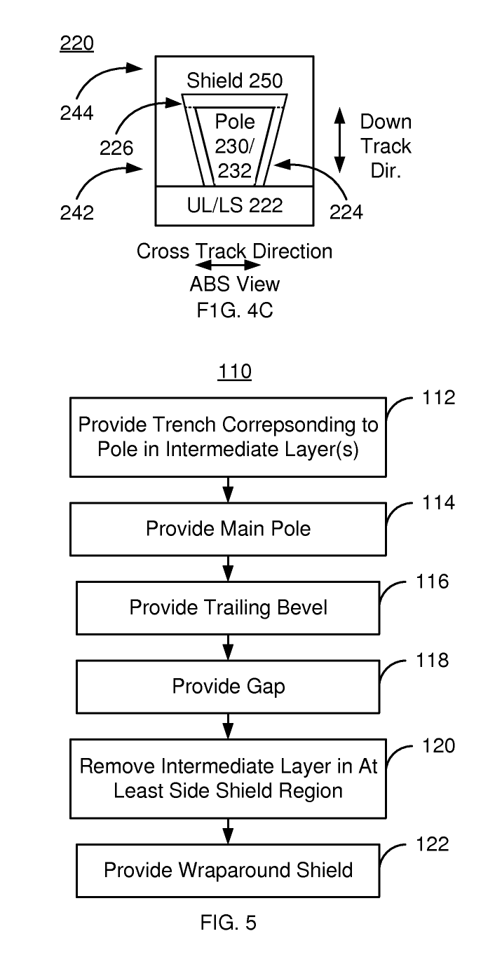

FIGS. 4A-4C depict various views of a disk drive and transducer formed using the method 100. FIG. 4A depicts a side view of an exemplary embodiment of a portion of a disk drive 200 including a write transducer 220. FIGS. 4B and 4C depict cross-sectional side (apex) and ABS views, respectively, of the transducer 220. For clarity, FIGS. 4A, 4B and 4C are not to scale. For simplicity not all portions of the disk drive 200 and transducer 220 are shown. In addition, although the disk drive 200 and transducer 220 are depicted in the context of particular components other and/or different components may be used. For example, circuitry used to drive and control various portions of the disk drive 200 is not shown. For simplicity, only single components 202, 210, 220, 222, 230 and 240 are shown. However, multiples of each components 202, 210, 220, 222, 230, 240 and/or their sub-components, might be used. The disk drive 200 may be a perpendicular magnetic recording (PMR) disk drive. However, in other embodiments, the disk drive 200 may be configured for other types of magnetic recording included but not limited to heat assisted magnetic recording (HAMR).

The disk drive 200 includes media 202, a slider 210 and a write transducer 220. Additional and/or different components may be included in the disk drive 200. Although not shown, the slider 210 and thus the transducer 220 are generally attached to a suspension (not shown). The transducer 220 is fabricated on the slider 210 and includes an air-bearing surface (ABS) proximate to the media 202 during use. In general, the disk drive 200 includes a write transducer 220 and a read transducer (not shown). However, for clarity, only the write transducer 220 is shown. The transducer 220 includes a main pole 230, coils 222, shields 240, side gap 224 and top gap 226. In other embodiments, different and/or additional components may be used in the write transducer 220.

The coil(s) 222 are used to energize the main pole 230. Two turns 222 are depicted in FIG. 4A. Another number of turns may, however, be used. Note that only a portion of the coil(s) 222 is shown in FIG. 4A. If, for example, the coil(s) 222 form a helical coil, then additional portion(s) of the coil(s) 222 may be located on the opposite side of the main pole 230 as is shown. If the coil(s) 222 is a spiral, or pancake, coil, then additional portions of the coil(s) 222 may be located further from the ABS. Further, additional coils may also be used.

The main pole 230 includes a pole tip region 232 close to the ABS and a yoke region 234 recessed from the ABS. The pole tip region 232 is shown as having top and bottom bevels 231 and 233, respectively, near the ABS. The sidewalls and form sidewall angles with the down track direction.

Also shown are side gaps 224 and top gap 226 that separate the main pole 230 from the shield 240. As can best be seen in FIG. 4C, the gaps 224 and 226 are separated by a dashed line indicating that these layers may be formed separately. The gaps 224 and 226 are nonmagnetic and may be include the same or different material(s). In the ABS view, the side gap 224 is conformal to the sidewalls of the pole 230. However, recessed from the ABS, the side gap 224 may not be conformal with the pole 230. The shield 240 is depicted as including a side shield portion 242 and a trailing shield 244. The side shields 242 are adjacent to the sides of the main pole 230 and the side gap 224. The trailing shield 244 is on top of the main pole and adjacent to the top gap 226.

The magnetic disk drive 200 may exhibit improved performance. The shield 240 does not include an interface between the trailing portion 244 and the side shields 242. Thus, the shield 240 is less prone to defects that adversely affect performance and reliability. For example, issues such as adjacent track interference may be mitigated. In addition, fabrication of the transducer 200 may be simplified. As a result, yield for the method 100 that is used to fabricate the transducer 200 may be improved.

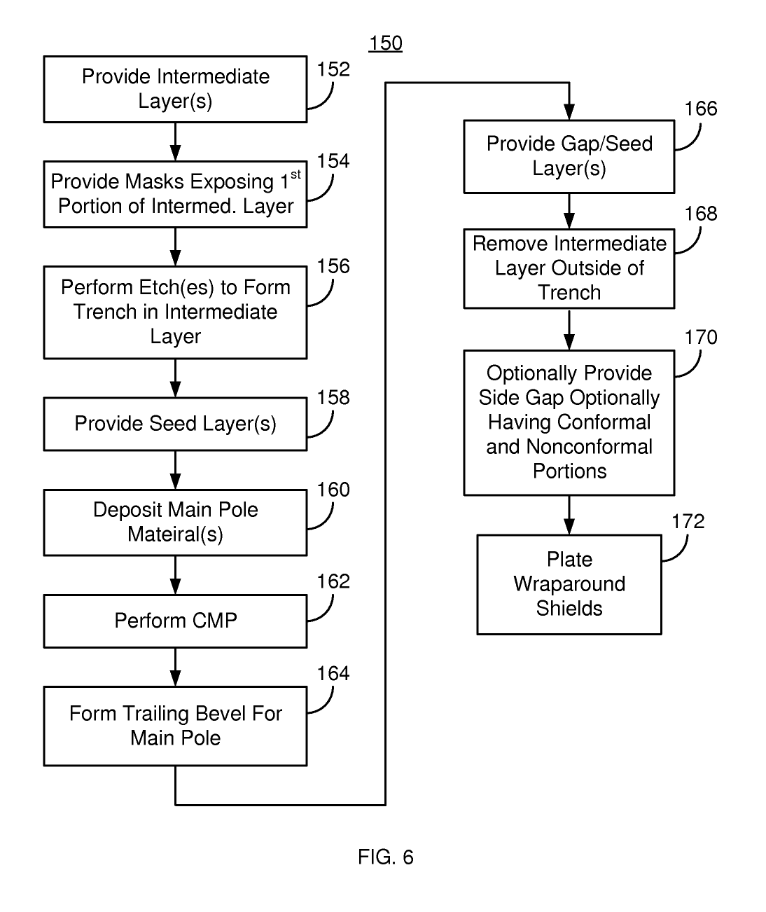

FIG. 5 depicts an exemplary embodiment of a method 110 for providing a magnetic recording transducer. For simplicity, some steps may be omitted, interleaved, performed in another order (unless otherwise indicated) and/or combined. The method 110 is described in the context of providing a magnetic recording disk drive 200 and transducer 220 depicted in FIGS. 4A-4C. However, the method 110 may be used to fabricate multiple magnetic recording heads at substantially the same time. The method 110 may also be used to fabricate other magnetic recording transducers. The method 110 is also described in the context of particular layers. A particular layer may include multiple materials and/or multiple sub-layers. The method 110 also may start after formation of other portions of the magnetic recording head. For example, the method 110 may start after a read transducer, return pole/shield and/or other structure have been fabricated.

Referring to FIGS. 4A-4C and 5, a trench is provided in the intermediate layer, via step 112. The trench corresponds to the location and shape of the main pole 230 to be provided. In some embodiments, the trench has different sidewall angles in the yoke region and the pole tip region. The main pole may then be provided in the trench, with the exception of forming the trailing bevel, via step 114. In some embodiments, step 114 includes depositing a seed layer such as Ru. In some embodiments, the seed layer provided in step 114 may form part of the gap 224 and may be a stop layer for a removal process for the intermediate layer. The magnetic material(s) for the pole 230 are then provided. For example, the magnetic material(s) may be plated. A planarization step, such as a CMP may then be performed. Thus, the top (trailing) surface of the pole 230 is flat.

The trailing bevel 233 is provided in the main pole, via step 116. Step 116 may include milling the pole tip region of the main pole while the yoke region is covered by a mask. Thus, the top surface of the main pole is at an acute angle from the direction perpendicular to the ABS.

The top gap 226 is provided, via step 118. In some embodiments, step 118 includes providing the write gap only. In such embodiments, the side gap is formed by the seed layer provided for the main pole. Thus, a nonmagnetic layer is provided on the top/trailing (e.g. beveled) surface 233 of at least the pole tip portion 232 of the main pole 230. In such embodiments, the thickness of the side gap may be tailored separately from the seed layer/write gap 226. In other embodiments, the top/trailing gap 226 and at least part of the side gap 224 are provided in step 118. The side gap 224 may have a conformal portion and a nonconformal portion. The conformal portion of the side gap is at least in the pole tip region.

The portion of the intermediate layer in at least the region in which the side shields are to be formed is removed, via step 120. Step 120 occurs after step 116. Thus, the trailing bevel is formed before the removal of the intermediate layer in step 210. In some embodiments, step 120 includes performing a wet etch. Thus, the seed layer provided in step 114 may be a stop layer for the wet etch.

The wraparound shield 230 is provided, via step 122. Step 122 thus includes providing magnetic material(s) for the side shield and trailing shield portions of the wraparound shield.

Using the method 110, a pole, side gap, and wraparound shield having the desired configuration may be provided for the transducer. More specifically, the wraparound shield may have no interface between the side shield and trailing shield portions. Reliability may be improved without significantly complicating fabrication and at relatively modest cost.

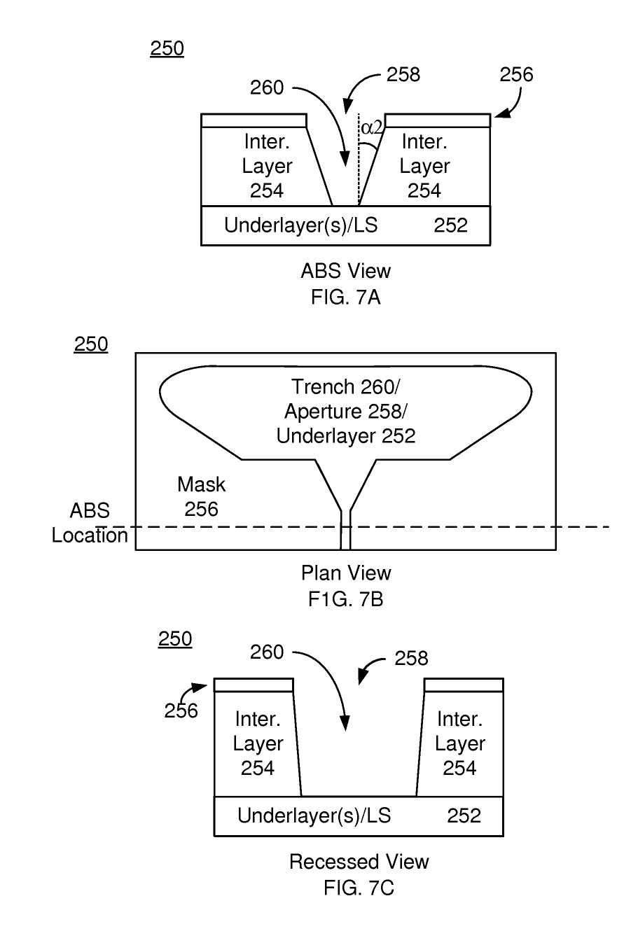

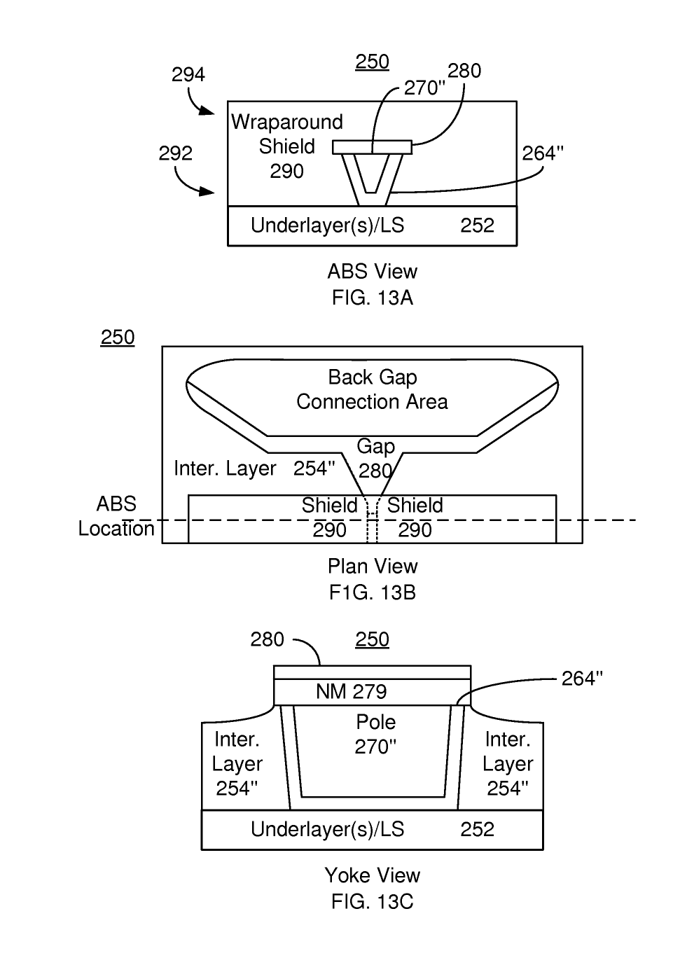

FIG. 6 depicts an exemplary embodiment of a method 150 for providing a magnetic recording transducer. For simplicity, some steps may be omitted, interleaved, performed in another order unless otherwise indicated and/or combined. FIGS. 7A-C though FIGS. 13A-C depict an exemplary embodiment of a transducer 250 during fabrication using the method 150. Referring to FIGS. 6-13C, the method 150 may be used to fabricate multiple magnetic recording heads at substantially the same time. The method 150 may also be used to fabricate other magnetic recording transducers. The method 150 is also described in the context of particular layers. A particular layer may include multiple materials and/or multiple sub-layers. The method 150 also may start after formation of other portions of the magnetic recording transducer. For example, the method 150 may start after a read transducer, return pole/shield and/or other structure have been fabricated.

The intermediate layer(s) in which the pole is to be formed are provided, via step 152. Step 152 may include depositing multiple materials in different regions of the transducer. In other embodiments, a single layer may be provided. Step 152 may be carried out by providing aluminum oxide and/or silicon oxide layer(s).

A mask having an aperture corresponding to the trench is provided, via step 154. Step 154 may include multiple substeps. For example, hard mask layer(s) may be provided. A mask including line corresponding to the pole tip may be provided on an intermediate layer, on the hard mask layer(s). The line mask may be a photoresist mask. Hard mask layer(s) may be provided on the line mask and the line mask removed. The hard mask layer may thus have an aperture therein. The aperture corresponds to the location and shape of a trench desired to be formed in the intermediate layer for the pole.

The trench is then formed in the intermediate layer, via step 156. Step 156 may be using an aluminum oxide RIE. For example, an aluminum oxide RIE may be used for an aluminum oxide intermediate layer. FIGS. 7A, 7B and 7C depict ABS, plan and yoke views, respectively, of the transducer 250 after step 156 is performed. An underlayer/leading shield 252 has been formed. The underlayer 252 may include a leading shield at and near the ABS. Further from the ABS, the underlayer 252 may be another nonmagnetic layer. An intermediate layer 254 and mask 256 having an aperture 258 therein is provided. The trench 260 has been formed in the intermediate layer 254.

A seed layer that is resistant to an etch of the intermediate layer is deposited in the trench, via step 158. For example, step 158 may include depositing a Ru seed layer via chemical vapor deposition.

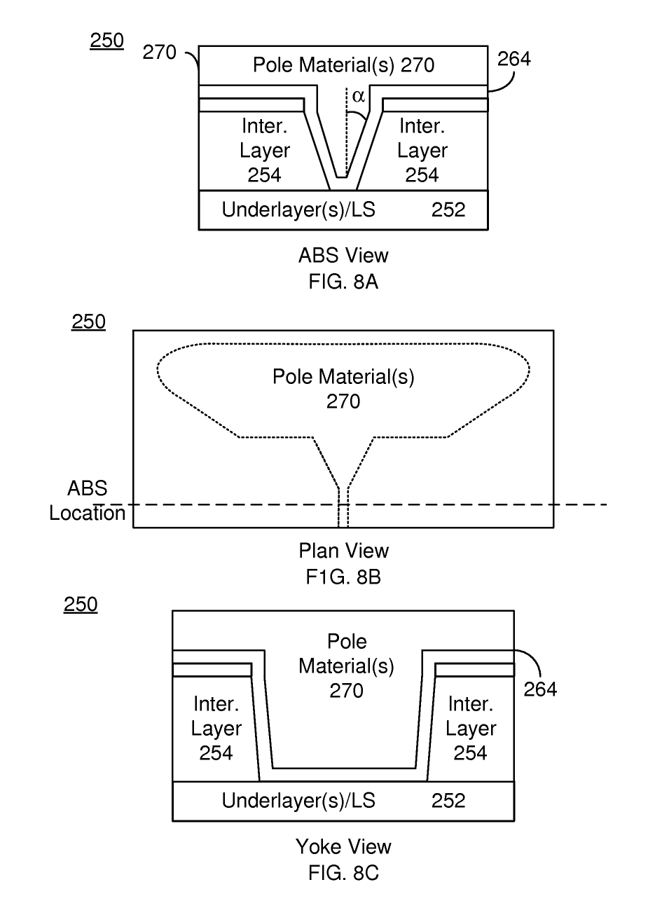

Materials for the pole are deposited, via step 160. Step 160 may include plating high saturation magnetization materials. FIGS. 8A, 8B and 8C depict ABS, plan and recessed views of the transducer 250 after step 160 is performed. Consequently, the main pole materials 270 and seed layer 264 are shown. Note that a portion of the pole materials 270 reside outside of the trench 260. In addition, the pole materials 270 have a sidewall angle, a, in the trench 260.

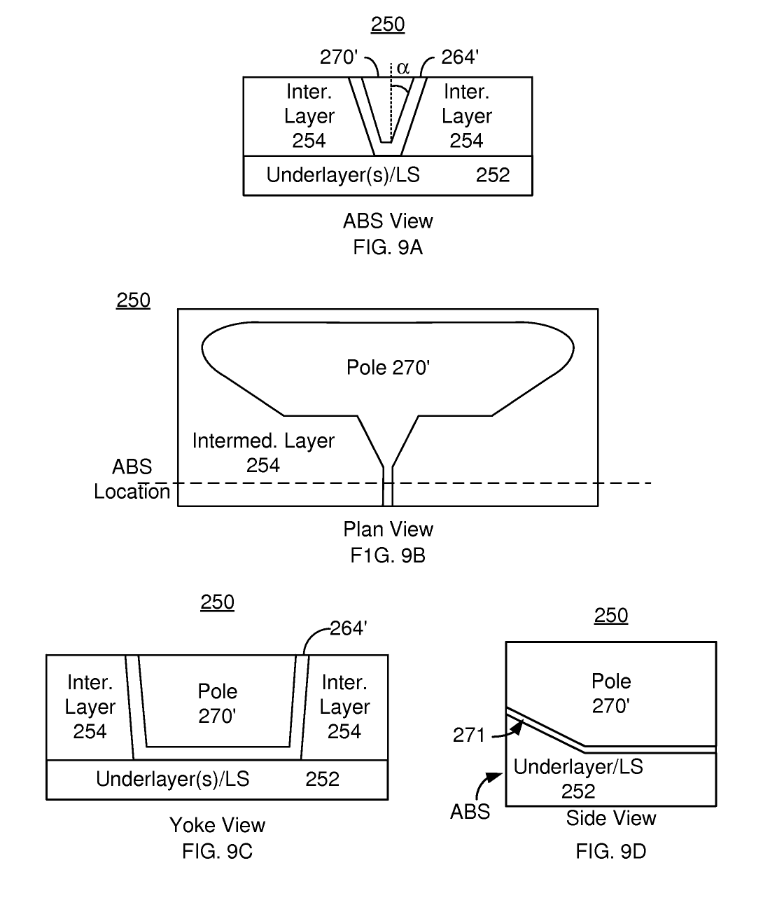

Excess pole materials may also be removed in step 162. For example, a chemical mechanical planarization (CMP) may be used to remove pole materials outside of the trench. In addition, an ion mill may be used to remove the portion of the seed layer 264 outside of the trench. FIGS. 9A, 9B, 9C and 9dD depict ABS, plan, recessed and apex views of the transducer 250 after step 162 is performed. Thus, main pole 270′ and remaining seed layer 264′ are shown.

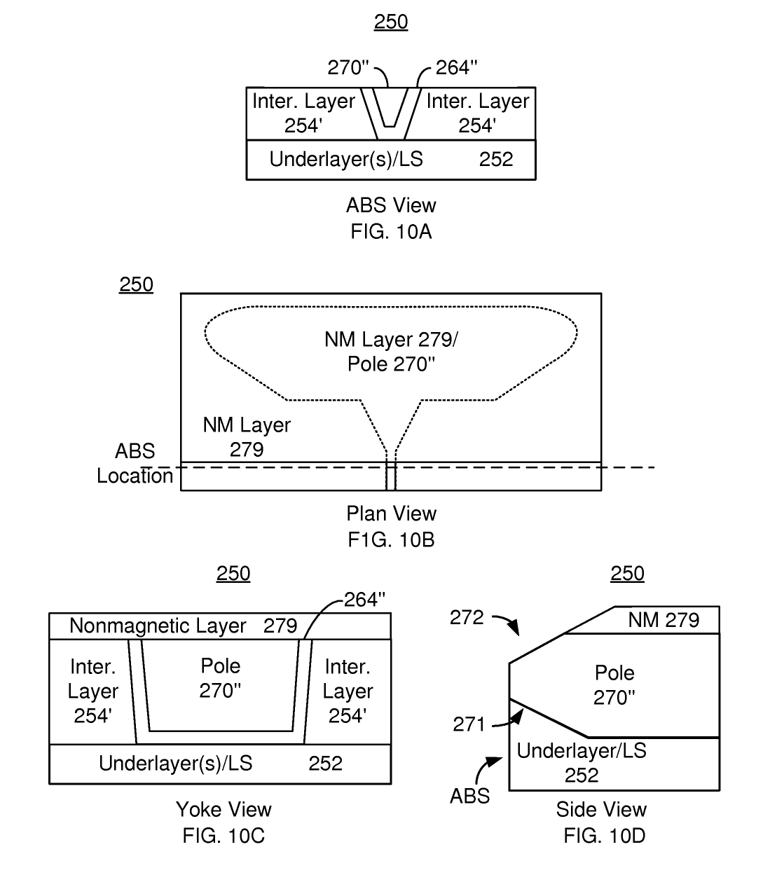

A trailing bevel is formed in the main pole 270′, via step 164. Step 164 may include providing a nonmagnetic layer on part of the main pole 270′ recessed from the ABS. An ion mill is carried out at a nonzero angle from the normal to the top (trailing) surface of the main pole. FIGS. 10A, 10B, 10C and 10D depict ABS, plan, yoke and side (apex) views of the transducer 250 after step 164 has been performed. Thus, a nonmagnetic layer 279 has been provided on the main pole. As can be seen in FIG. 10D, the ion mill performed in step 164 has formed a trailing bevel 272 in the main pole 270″. The nonmagnetic layer 279 may also have an angled surface. At the ABS, the top surface/trailing bevel 272 of the main pole 270″ is exposed. In addition, a portion of the intermediate layer 254′ and seed layer 264″ has been removed. However, recessed from the ABS, the pole 270″ is covered by the nonmagnetic layer 279 and not removed.

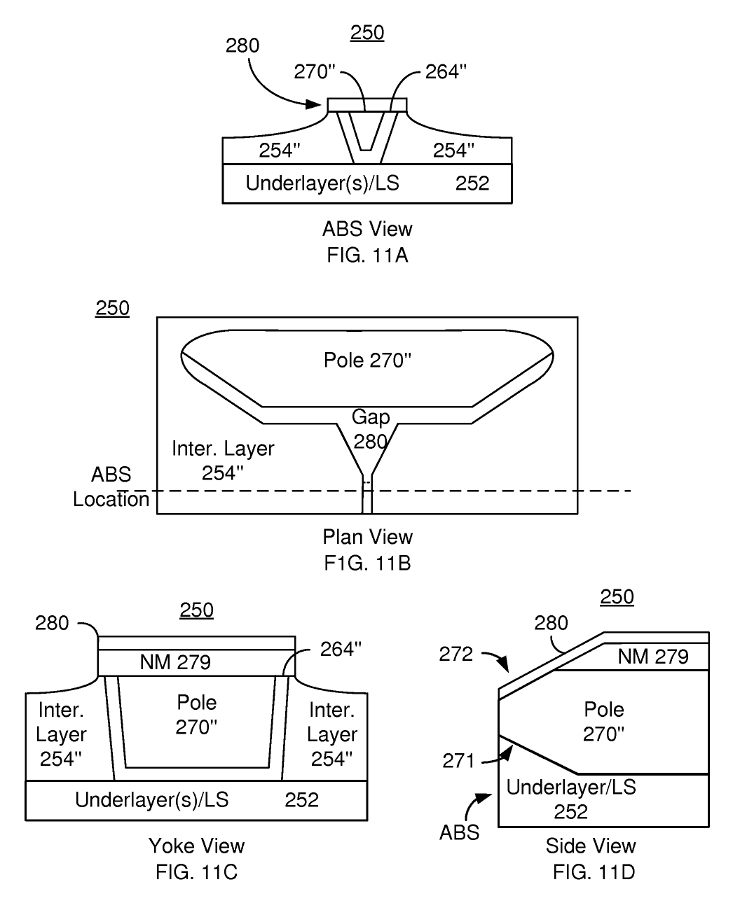

After the trailing bevel has been formed in step 164, the top gap layer is provided, via step 166. Step 166 typically includes full film depositing a not least one nonmagnetic gap layer, such as Ru. In addition, a high moment seed layer for the shield may be full film deposited. This seed layer may be magnetic. The gap and seed layers may then be patterned. The portion of the gap layer on the pole 270″ is covered by a mask. The exposed portion(s) of the gap/seed layers may then be removed. FIGS. 11A, 11B, 11C and 11D depict ABS, plan, yoke and side (apex) views of the transducer 250 after step 166 has been performed. Thus, nonmagnetic gap layer 280 has been provided. In the embodiment shown, no separate seed layer is shown. Because of patterning of the gap 280, a portion of the intermediate layer 254″ has been removed. This may be seen in FIGS. 11A and 11C.

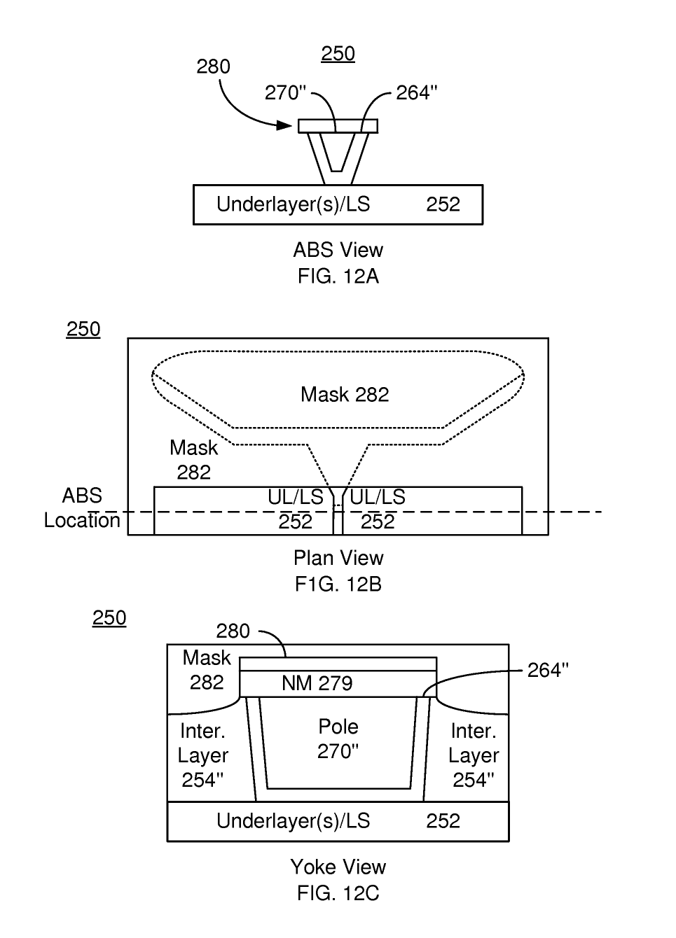

A portion of the intermediate layer 254″ outside of the trench may be removed, via step 168. Step 168 is performed after the bevel has been fabricated in step 164. This portion of the intermediate layer 254″ that has been removed corresponds to the location of the side shield(s) to be formed. For example, a mask having an aperture over these regions may be provided and a wet etch appropriate for this portion of the intermediate layer 254″ removed. FIGS. 12A, 12B and 12C depict ABS, plan and yoke views of the transducer 200 after step 168 is completed. Thus, a mask 282 having an aperture has been formed. The aperture is around the main pole 270″ and includes the ABS location (portion at which the ABS is formed, for example via lapping). A mask 282 has thus been provided. As can be seen in FIGS. 12A-12B, the underlayer/leading shield 252, the seed layer 264″ and the gap 280 are exposed at and near the ABS. However, in the recessed view, the intermediate layer 254″ remains.

The side gap may optionally be configured to have conformal and nonconformal portions, via step 170. In some embodiments, this may include refilling a portion of the trench not filed with pole material(s) 270″ with nonmagnetic material(s). However, in other embodiments, step 170 may be skipped.

The shields are provided, via step 172. Step 172 may include depositing a high permeability material, such as NiFe, while the mask 282 is in place. This may include plating such a material. The mask 282 may then be removed. FIGS. 13A, 13B and 13C depict ABS, plan and recessed views of the transducer 250 after step 172 is performed. Thus, wraparound shield 290 is shown. As can be seen in FIG. 13A, the wraparound shield 290 includes side shields 292 and trailing shield 294. Also in the embodiment shown, the shield 290 does not extend to the yoke view. However, in other embodiments, the shield 290 may extend a different distance in the stripe height direction. Further, as can be seen in FIG. 13A, there is no interface between the side shields 292 and the trailing shield 294.

Using the method 150, the magnetic transducer 250 may be provided. Thus, benefits analogous to those of the magnetic transducer 220 may be achieved. For example, reduced adjacent track interference and improved reliability may be attained for the transducer 250. This may be achieved while simplifying fabrication and at a reduced cost.

We claim:

1. A method for fabricating magnetic transducer having air-bearing surface (ABS) location comprising:
providing a main pole, the main pole having a plurality of sidewalls, the step of providing the main pole including providing a trailing bevel;
providing a side shield after the trailing bevel has been provided.

2. The method of claim 1 wherein the magnetic transducer includes an intermediate layer, the method further comprising:
forming a trench in the intermediate layer using at least one etch, the trench having a location and profile corresponding to the main pole; and
wherein the step of providing the main pole further includes providing the main pole in the trench.

3. The method of claim 2 wherein the step of providing the main pole in the trench further includes:
depositing at least one nonmagnetic layer, a portion of the at least one nonmagnetic layer residing in the trench;
providing at least one magnetic pole material; and
planarizing the at least one magnetic pole material.

4. The method of claim 2 further comprising:
providing a conformal portion of a side gap such that at least a portion of the main pole is conformal with the trench.

5. The method of claim 1 wherein the main pole has a bottom and a top wider than the bottom.

6. The method of claim 1 wherein the step of providing the main pole further includes:
ion milling the main pole to form the trailing bevel

7. The method of claim 2 wherein the step of providing the side shield further includes:
depositing at least one nonmagnetic gap layer on a portion of the pole; and
removing a portion of the intermediate layer adjacent to the main pole.

8. The method of claim 7 wherein the side shield is part of a wraparound shield and wherein the step of providing the side shield further includes:
plating the wraparound shield.

9. A method for fabricating magnetic transducer having air-bearing surface (ABS) location comprising:
providing an intermediate layer;
providing at least one mask on the intermediate layer and having an aperture therein;
performing at least one etch to remove a first portion of the intermediate layer exposed by the aperture and to form a trench therein, the trench having a location and a profile corresponding to a main pole;
depositing at least one nonmagnetic layer, a portion of the at least one nonmagnetic layer residing in the trench;
depositing at least one magnetic pole material;
planarizing the at least one magnetic pole material;
ion milling a portion of the at least one magnetic pole material to provide a trailing bevel and form the main pole;
providing a nonmagnetic write gap on the main pole;
removing a second portion of the intermediate layer adjacent to the main pole; and
providing a side shield after the ion milling step and after the step of removing the second portion of the intermediate layer, a portion of the at least one nonmagnetic layer forming at least a portion of the side gap, the side gap residing between the side shield and the main pole.

10. The method of claim 9 wherein the side shield is part of a wraparound shield and wherein the step of providing the side shield further includes:
providing the wraparound shield.
